(19) United States
(12) Patent Application Publication
(10) Pub. No.: US 2021/0166896 A1
(43) Pub. Date: Jun. 3, 2021

(54) SWITCH UNIT AND METHOD FOR PRODUCING SWITCH SUBSTRATE

(71) Applicants: CITIZEN ELECTRONICS CO., LTD., Yamanashi-ken (JP); CITIZEN WATCH CO., LTD., Tokyo (JP)

(72) Inventors: Ken ITO, Yamanashi-ken (JP); Mitsunori MIURA, Yamanashi-ken (JP); Shinsuke WATANABE, Yamanashi-ken (JP); Kensuke IKEDA, Yamanashi-ken (JP)

(21) Appl. No.: 17/251,906

(22) PCT Filed: Aug. 1, 2019
(86) PCT No.: PCT/JP2019/030147

§ 371 Date: Dec. 14, 2020

(30) Foreign Application Priority Data
Aug. 2, 2018 (JP) 2018-145733
Nov. 22, 2018 (JP) 2018-218997
Jan. 16, 2019 (JP) 2019-005118

(51) Int. Cl. H01H 13/704; H01H 13/7073

(52) U.S. Cl. CPC H01H 13/704; H01H 2227/008; H01H 13/7073

(57) ABSTRACT

A switch unit includes a substrate, which includes a hard layer and a soft layer; a first contact point above the soft layer; a second contact point around the first contact point; a conduction spring member which is elastically deformable into contact with the first contact point to make a conduction between the first contact point and the second contact point; a first external electrode; a first through-hole electrode which is electrically connected to the first contact point; and a first wiring pattern, which is electrically connected to the first external electrode and the first through-hole electrode.

### TECHNICAL FIELD

The present application relates to a switch unit having noiselessness and a method for producing a switch substrate.

### BACKGROUND ART

Conventionally, a push-type switch device includes: a switch substrate; a contact member formed on the switch substrate; and a pressing member made up of elements such as a conductive flat spring that is brought into contact with the contact member to make a conduction. In this push-type switch device, a switching operation is performed by elastically deforming the pressing member toward the contact member. FIG. 34 illustrates one example of a switch unit 201, which constitutes a conventional switch device. The switch unit 201 includes a switch substrate 202, a first contact point 13, a second contact point 14, and a conduction spring member 15, which is a pressing member.

The switch unit 201 is mounted on a mount substrate 23, such as a mother board. Generally, the switch substrate 202 is made of a hard material such as a glass epoxy substrate (FR-4). The first contact point 13 is provided at a center portion on the switch substrate 202. The second contact point 14 is provided around the first contact point 13. The conduction spring member 15 is provided over the first contact point 13 and the second contact point 14, which are contact members, and is elastically deformable to contact the first contact point 13, thereby making a conduction between the first contact point 13 and the second contact point 14.

While the pressing member is being pressed, there is a conduction between the pressing member and the contact members. Upon release from the pressing state, the conduction between the pressing member and the contact members is broken. In this press manipulation, contact sound is generated at the time when the pressing member contacts the contact members. This contact sound serves as a way of confirming that a switching is performed reliably. If, however, the contact sound generated is higher than necessary, the contact sound is equivalent to impact sound.

In order to reduce such contact sound generated at the time of a switching operation, some switch devices have been proposed that incorporate a material such as a shock-absorbing material and a sound-absorbing material between the switch substrate and the pressing member. Patent document 1 discloses a switch device that includes a cover member, a click sheet, a buffer conductive sheet, and a switch substrate having a fixed contact formed on a surface of the switch substrate. In this cover member, a base and a key top are connected to each other at a skirt. The key top has a plunger that is formed on the lower surface of the key top and that protrudes downward. Patent document 2 and patent document 3 disclose switch devices each including: a switch substrate having a pair of contact members provided on a surface of the switch substrate; a pressing member made of a dome-shaped metal plate having a property of a deformable spring; and a shock-absorbing material provided between the switch substrate and the pressing member.

Patent document 4 discloses a touch panel device that includes: a touch panel substrate; a transmitter that transmits an elastic surface wave to the touch panel substrate; a receiver that receives the elastic surface wave that has been transmitted through the touch panel substrate; and a sheet material serving as a pressing member. The sheet material has an input surface and is provided at a distance from the touch panel substrate such that the surface opposite to the input surface faces the touch panel substrate. The sheet material is flexible and includes: a soft layer made of a soft material; and a pair of hard layers made of a hard material harder than the soft material. By pressing the input surface, the pressed portion is partially bent into contact with the touch panel substrate.

### RELATED ART DOCUMENTS

### Patent Documents

Patent document 1: JP 2001-43772A

Patent document 2: JP 2012-243609A

Patent document 3: JP 2017-79133A

Patent document 4: JP 2009-3672A

### SUMMARY OF INVENTION

### Technical Problem

In the switch device recited in patent document 1, the buffer conductive sheet is provided on the switch substrate. In this switch device, the buffer conductive sheet is provided with a predetermined degree of hardness to improve click sensitivity. This switch device, however, has no structure that decreases contact sound generated by clicking. In the switch devices recited in patent document 2 and patent document 3, a shock-absorbing material is provided between the switch substrate and the pressing member in order to decrease contact sound generated at the time when the pressing member is pressed into contact with the switch substrate. This shock-absorbing material, however, is made up of an upper sheet and a lower sheet attached to each other via a spacer sheet having a removal hole at a position corresponding to a fixed contact portion. This leaves a gap between the upper sheet and the lower sheet, and the gap may undermine the click sensitivity of the shock-absorbing material.

In the touch panel device recited in patent document 4, the sheet material facing the touch panel substrate is made up of: a hard layer that maintains the shape of the sheet material; and a soft layer covering the hard layer. This configuration decreases the contact sound generated at the time when the sheet material is pressed toward the touch panel substrate. However, the soft layer may absorb the repulsive force generated when the sheet material is pressed toward the touch panel substrate, undermining the click sensitivity of the sheet material. Also, it is not easy to produce a sheet material made up of a soft layer and a hard layer while securing a predetermined distance from the touch panel substrate, and there may be stroke variations occurring when the sheet material is pressed toward the touch panel substrate.

In light of the considerations above, it is an object of the present application to provide a switch unit including a switch substrate that decreases contact sound generated at the time of switching without undermining switching operability.

### Solution to Problem

A switch unit according to a first embodiment of the present application includes: a substrate including a hard layer and a soft layer; a first contact point provided on an upper surface of the substrate and above the soft layer; a second contact point provided on the upper surface of the substrate and around the first contact point; a conduction spring member provided in a non-contact state with the first contact point above the first contact point and in contact state with the second contact point, the conduction spring member being elastically deformable into contact with the first contact point to make a conduction between the first contact point and the second contact point; a first external electrode provided at an end portion of the substrate; a first through-hole electrode provided at an inside portion of the substrate and electrically connected to the first contact point; and a first wiring pattern provided on a lower surface of the substrate and electrically connected to the first external electrode and the first through-hole electrode.

A switch unit according to a second embodiment of the present application includes: a substrate including a hard layer and a soft layer; a first contact point provided on an upper surface of the substrate and above the soft layer; a second contact point provided on the upper surface of the substrate and around the first contact point; a conduction spring member provided in a non-contact state with the first contact point above the first contact point and in contact state with the second contact point, the conduction spring member being elastically deformable into contact with the first contact point to make a conduction between the first contact point and the second contact point; a first external electrode and a second external electrode provided at end portions of the substrate; a first connection electrode provided at an inside portion of the substrate and electrically connecting the first contact point and the first external electrode to each other; and a second connection electrode provided at an inside portion of the substrate and electrically connecting the second contact point and the second external electrode to each other.

A switch unit according to a third embodiment of the present application includes a substrate, a first contact point, a second contact point, and a conduction spring member. The substrate includes: a cavity formed in the substrate; an opening formed on an upper surface of the substrate; and a connection hole connecting the opening and the cavity to each other. The first contact point is provided on the upper surface of the substrate. The second contact point is provided around the first contact point. The conduction spring member is provided in a non-contact state with the first contact point above the first contact point and in contact state with the second contact point, the conduction spring member being elastically deformable into contact with the first contact point to make a conduction between the first contact point and the second contact point. A maximum value of a sectional area of the connection hole parallel to the upper surface of the substrate is smaller than a maximum value of a sectional area of the cavity parallel to the upper surface of the substrate.

A method for producing the switch substrate according to the first embodiment of the present application includes a forming step of obtaining an aggregate switch substrate by forming a soft layer on a lower surface of an aggregate switch substrate member. The aggregate switch substrate member includes: an aggregate substrate including a hard layer; a plurality of first contact points provided on an upper surface of the aggregate substrate; a plurality of second contact points provided on the upper surface of the aggregate substrate and around the respective first contact points; a plurality of first through-hole electrodes provided at an inside portion of the aggregate substrate and electrically connected to the respective first contact points; a plurality of second through-hole electrodes electrically connected to the respective second contact points; a plurality of through holes extending between the upper surface and a lower surface of the aggregate substrate, each through hole of the through holes including a conduction layer as a side surface of the each through hole; a plurality of first wiring patterns provided on a lower surface of the aggregate substrate, each first wiring pattern of the first wiring patterns being electrically connected to the conduction layer and each first through-hole electrode of the first through-hole electrodes; and a plurality of second wiring patterns each electrically connected to the conduction layer and each second through-hole electrode of the second through-hole electrodes. The soft layer covers at least portions immediately under the plurality of first contact points, and does not cover the plurality of through holes. The method also includes a cutting step of obtaining individual switch substrates by cutting the aggregate switch substrate through at least the plurality of through holes.

A method for producing the switch substrate according to the second embodiment of the present application includes a joining step of obtaining an aggregate switch substrate by joining a first aggregate substrate and a second aggregate substrate to each other. The first aggregate substrate includes: a plurality of first contact points formed on an upper surface of the first aggregate substrate; a plurality of second contact points provided around the respective first contact points and formed on the upper surface of the first aggregate substrate; and a plurality of through holes. The second aggregate substrate includes a plurality of cavities open on an upper surface of the second aggregate substrate. A maximum value of a sectional area of each of the cavities parallel to the upper surface of the first aggregate substrate is larger than a maximum value of a sectional area of each of the through holes parallel to the upper surface of the first aggregate substrate. The plurality of through holes overlap the plurality of respective cavities in a vertical direction. The method also includes a cutting step of obtaining individual switch substrates by cutting the aggregate switch substrate.

### Advantageous Effects of Invention

In the switch unit according to the first embodiment of the present application, the substrate includes a hard layer and a soft layer, and a first contact point is provided above the soft layer. This configuration ensures that the pressing force of pressing the conduction spring member is supported by the hard layer, and that the soft layer absorbs: the contact sound generated at the time when the conduction spring member contacts the first contact point; and the sound that is caused when a vibration involved in the collision of the conduction spring member with the first contact point is amplified and caused to propagate from the substrate. Thus, the switch unit according to the first embodiment decreases, without undermining switching operability: the contact sound generated at the time when the conduction spring member and the first contact point contact each other; and the sound that is caused when a vibration involved in the collision of the conduction spring member with the first contact point is amplified and caused to propagate from the substrate.

In the switch unit according to the third embodiment of the present application, sound generated near the first contact point is absorbed in, through the connection hole, the cavity extending between the opening formed on the upper surface of the substrate and the inside of the substrate. With this configuration, the switch unit according to the third embodiment decreases: the contact sound generated at the time when the conduction spring member and the first contact point contact each other; and the sound that is caused when a vibration involved in the collision of the conduction spring member with the first contact point is amplified and caused to propagate from the substrate.

In the method for producing the switch substrate according to the present application, an aggregate switch substrate is cut to obtain a switch substrate used in a switch unit having noiselessness. This ensures that a switch substrate used in a switch unit having noiselessness is efficiently produced.

### BRIEF DESCRIPTION OF DRAWINGS

FIG. 1 is a sectional view of a switch unit according to the first embodiment.

FIG. 2 is a sectional view of a switch device including the switch unit according to the first embodiment.

FIG. 3 is an exploded perspective view of the switch device including the switch unit according to the first embodiment.

FIG. 4 is a sectional view of a switch unit according to the second embodiment.

FIG. 5 is a sectional view of a switch unit according to the third embodiment.

FIG. 6 is a bottom view of the switch unit according to the third embodiment.

FIG. 7 is a sectional view of a switch unit according to the fourth embodiment.

FIG. 8 is a sectional view of a switch unit according to the fifth embodiment.

FIG. 9 is a sectional view of a switch unit according to the sixth embodiment.

FIG. 10 is a sectional view of a switch unit according to the seventh embodiment.

FIG. 11 is a sectional view of a switch unit according to the eighth embodiment.

FIG. 12 is a sectional view of a switch unit according to the ninth embodiment.

FIG. 13 is a plan view of an aggregate switch substrate member used as a material of a switch substrate of the switch unit according to the third embodiment.

FIG. 14 is a sectional view of the aggregate switch substrate member used as the material of the switch substrate of the switch unit according to the third embodiment.

FIG. 15 is a bottom view of the aggregate switch substrate member used as the material of the switch substrate of the switch unit according to the third embodiment.

FIG. 16 is a sectional view of the aggregate switch substrate member used as the material of the switch substrate of the switch unit according to the third embodiment.

FIG. 17 is a bottom view of the aggregate switch substrate member used as the material of the switch substrate of the switch unit according to the third embodiment.

FIG. 18 is a sectional view of a switch unit according to the tenth embodiment.

FIG. 19 is a sectional view of a switch device including the switch unit according to the tenth embodiment.

FIG. 20 is an exploded perspective view of the switch device including the switch unit according to the tenth embodiment.

FIG. 21(a) is a partial sectional view of the switch unit according to the tenth embodiment. FIG. 21(b) is a partial sectional view of a switch unit according to a modification of the tenth embodiment.

FIG. 22(a) is an exploded partial perspective view of a first substrate member and a second substrate member of the switch unit according to the tenth embodiment. FIG. 22(b) is a partial perspective view of a substrate of the switch unit according to the tenth embodiment.

FIG. 23 is a partial plan view of the substrate of the switch unit according to the tenth embodiment.

FIG. 24(a) is a partial plan view of a substrate of a switch unit according to the eleventh embodiment. FIG. 24(b) is a partial sectional view of the substrate of the switch unit according to the eleventh embodiment.

FIG. 25 is a partial plan view of a substrate of a switch unit according to the twelfth embodiment.

FIG. 26(a) is a partial plan view of a substrate of a switch unit according to the thirteenth embodiment. FIG. 26(b) is a partial plan view of a substrate of a switch unit according to the fourteenth embodiment.

FIG. 27(a) is a partial plan view of a substrate of a switch unit according to the fifteenth embodiment. FIG. 27(b) is a partial sectional view of the substrate of the switch unit according to the fifteenth embodiment.

FIG. 28(a) is a partial plan view of a substrate of a switch unit according to the sixteenth embodiment. FIG. 28(b) is a partial sectional view of the substrate of the switch unit according to the sixteenth embodiment.

FIG. 29 is a sectional view of a three-layer structure substrate of a switch unit according to another embodiment.

FIG. 30(a) is a partial perspective view of an aggregate first substrate having a plurality of connection holes and an aggregate second substrate having a plurality of cavities. FIG. 30(b) is a partial perspective view of an aggregate substrate in which the aggregate first substrate and the aggregate second substrate are joined to each other.

FIG. 31 is a plan view of an aggregate switch substrate member used as a material of a switch substrate of the switch unit according to the tenth embodiment.

FIG. 32 is a sectional view of the aggregate switch substrate member used as the material of the switch substrate of the switch unit according to the tenth embodiment.

FIG. 33 is a bottom view of the aggregate switch substrate member used as the material of the switch substrate of the switch unit according to the tenth embodiment.

FIG. 34 is a sectional view of a switch unit using a conventional switch substrate.

### DESCRIPTION OF EMBODIMENTS

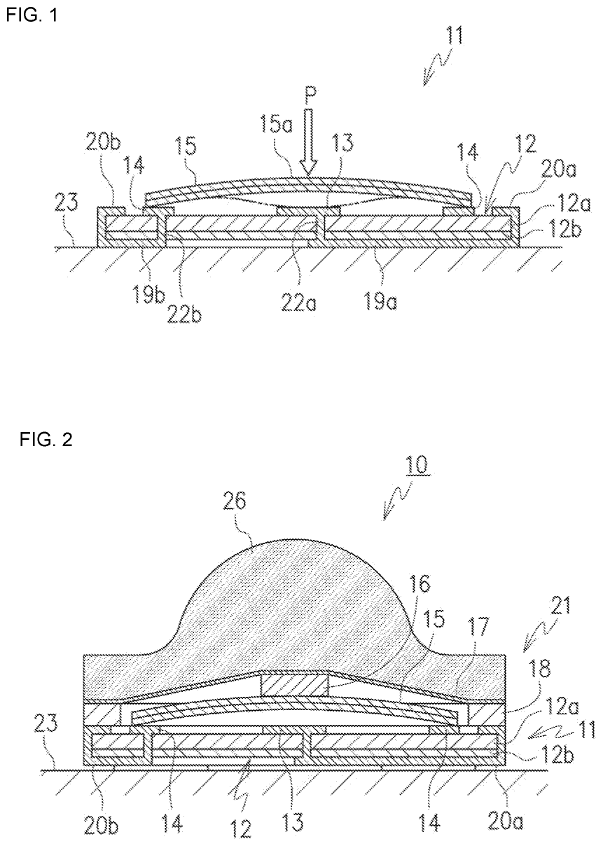

By referring to embodiments and drawings, detailed description will be made below with regard to a switch unit according to the present application and a method according to the present application for producing a switch substrate. It is to be noted that the drawings are schematic representations of a switch unit, a switch substrate, constituent elements of the switch unit and the switch substrate, and peripheral elements of the switch unit and the switch substrate. It is also to be noted that the dimensions and dimension ratios on the drawings may not necessarily be actual dimensions and dimension ratios. It is also to be noted that descriptions deemed redundant will not be repeated, as the case may be, and identical reference numerals will be assigned to identical elements. In the present application, by way of description, vertical directions and lateral directions are defined based on the directions indicated in the drawings, such as FIGS. 1, 11, and 18, unless noted otherwise.

FIG. 1 illustrates a basic configuration of a switch unit 11 according to the first embodiment of the present application. The switch unit 11 is provided on a mount substrate 23, such as a mother board. The switch unit 11 includes a substrate 12, a first contact point 13, a second contact point 14, and a conduction spring member 15. The substrate 12 includes a hard layer 12a and a soft layer 12b. The first contact point 13 is provided at the center of the upper surface of the substrate 12. The second contact point 14 is provided on the upper surface of the substrate 12 and around the first contact point 13.

The conduction spring member 15 is out of contact with the first contact point 13 above the first contact point 13_and is in contact with the second contact point 14. Specifically, the conduction spring member 15 is mounted on the upper surface of the second contact point 14 at an outer circumference portion of the conduction spring member 15, and faces the first contact point 13 at a center portion of the conduction spring member 15. The conduction spring member 15 is elastically deformable into contact with the first contact point 13 to make a conduction between the first contact point 13 and the second contact point 14. That is, the conduction spring member 15 serves as a pressing member of the switch unit 11.

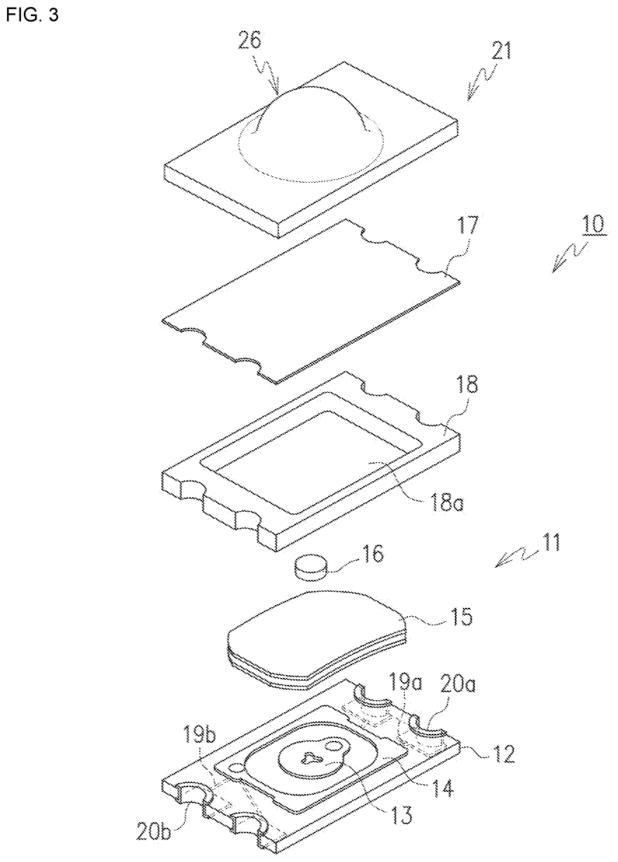

FIG. 2 illustrates a sectional structure of a switch device 10, which includes the switch unit 11. FIG. 3 illustrates an exploded structure of the switch device 10. As illustrated in FIGS. 2 and 3, a frame sheet 18 is provided on the substrate 12. The frame sheet 18 has, at its center, an opening 18a, which has a large quadrangular shape. The opening 18a contains the conduction spring member 15. The conduction spring member 15 has a size corresponding to the opening 18a and has a dome shape. The switch device 10 includes a pressing aid member 21 over the switch unit 11. The pressing aid member 21 includes: a flexible cover sheet 17, which covers the upper surface of the switch unit 11; and a pressing protrusion 26, which is provided over the cover sheet 17.

The cover sheet 17 is made up of a thin resin sheet of polyimide or phthalamide. On the inner surface of the cover sheet 17, a pressing element 16 is provided in advance. The pressing element 16 is in contact with an apex portion 15a of the conduction spring member 15. The pressing element 16 is provided for the purpose of reinforcing the pressing point of the apex portion 15a. The shape of the pressing element 16 may be other than the cylindrical shape illustrated in FIG. 3 and may be a protrusion shape such as a dome shape. The cover sheet 17 covers the conduction spring member 15 via the pressing element 16.

That is, as illustrated in FIGS. 2 and 3, the conduction spring member 15 is covered by the cover sheet 17, which includes the pressing element 16, which contacts the apex portion 15a. The circumference of the cover sheet 17 is bonded to the upper surface of the frame sheet 18. The cover sheet 17 may be mounted on the conduction spring member 15 in such a manner that the cover sheet 17 and the conduction spring member 15 are hot pressed to each other with the pressing element 16 housed in the cover sheet 17, whereby the cover sheet 17 and the conduction spring member 15 are integral to each other.

The substrate 12 includes: the upper hard layer 12a, on which the first contact point 13 and the second contact point 14 are provided; and the lower soft layer 12b. That is, as illustrated in FIG. 1, the substrate 12 according to the first embodiment has a two-layer structure made up of the upper hard layer 12a and the lower soft layer 12b. It is to be noted that the soft layer 12b is lower in hardness than the hard layer 12a. The hard layer 12a and the soft layer 12b have approximately the same shapes. The hard layer 12a and the soft layer 12b may be joined to each other by: radiating ultrasonic or laser to their joint surfaces; or via a bonding layer such as a binder or a bonding sheet (neither of which is illustrated) of epoxy resin or acrylic resin.

The first contact point 13 and the second contact point 14 may be prepared by patterning such as etching of an electrode film, such as copper foil, formed on the upper surface of the hard layer 12a. At both end portions of the substrate 12, a first external electrode 20a and a second external electrode 20b are provided respectively. At an inside portion of the substrate 12, a first through-hole electrode 22a and a second through-hole electrode 22b are provided. The first through-hole electrode 22a is electrically connected to the first contact point 13, and the second through-hole electrode 22b is electrically connected to the second contact point 14. That is, the first through-hole electrode 22a and the second through-hole electrode 22b of the switch unit 11 penetrate the substrate 12.

Also, on the lower surface of the substrate 12, that is, on the lower surface of the soft layer 12b, a first wiring pattern 19b and a second wiring pattern 19b are provided. The first wiring pattern 19b is electrically connected to the first external electrode 20a and the first through-hole electrode 22a, and the second wiring pattern 19b is electrically connected to the second external electrode 20b and the second through-hole electrode 22b. The first wiring pattern 19b and the second wiring pattern 19b may be prepared by patterning such as etching of an electrode film, such as copper foil, formed on the lower surface of the soft layer 12b. Also, the first external electrode 20a and the second external electrode 20b may be prepared by patterning such as etching of an electrode film, such as copper foil, formed on the side surfaces of the hard layer 12a and the soft layer 12b.

The conduction spring member 15 is made up of elements such as a metal takt spring having a dome shape. The conduction spring member 15, at its center portion, is out of contact with the first contact point 13 while no external force is being added to the conduction spring member 15. As illustrated in FIG. 1, a switching operation is performed by pressing and elastically deforming the apex portion 15a of the conduction spring member 15 in the direction indicated by arrow line P, thereby bringing the reverse apex portion 15a into contact with the first contact point 13.

Since the upper part of the substrate 12 is the hard layer 12a, the first contact point 13 is able to reliably receive the pressing force from the conduction spring member 15. This ensures a stable switching stroke of the switch unit 11, resulting in a reliable switching operation. Also, the soft layer 12b is provided at a lower portion of the hard layer 12a and under the first contact point 13; in the first embodiment, the soft layer 12b is provided immediately under the first contact point 13. This configuration enables the soft layer 12b to absorb: the contact sound generated at the time when the conduction spring member 15 contacts the first contact point 13 (the contact sound generated at the time when the conduction spring member contacts the first contact point will be hereinafter occasionally referred to simply as “contact sound”); and the sound that is caused when a vibration involved in the collision of the conduction spring member 15 with the first contact point 13 amplified and caused to propagate from the substrate 12 (the sound that is caused when a vibration involved in the collision of the conduction spring member with the first contact point is amplified and caused to propagate from the substrate will be hereinafter occasionally referred to as “amplification sound”).

Thus, the switch unit 11 has reliable switchability and noiselessness. It is to be noted that there is no particular limitation to the layer thicknesses of the hard layer 12a and the soft layer 12b. It is preferable, however, that the hard layer 12a has a substantial degree of thickness, since the strength of the substrate as a whole and switching stability depend on the hard layer 12a. In contrast, the soft layer 12b may be thinner than the hard layer 12a, since it is sufficient for the soft layer 12b to be thick enough to absorb the contact sound and the amplification sound generated at the time when the conduction spring member 15 contacts the first contact point.

The hard layer 12a may be made of, for example, glass epoxy resin such as FR-4. The soft layer 12b may be made of, for example, polyimide resin. The soft layer 12b is preferably made of polyimide resin having a Rockwell hardness of from 30 to 130 HRM. It is to be noted that there is no limitation to the materials of the hard layer 12a and the soft layer 12b insofar as the materials have an insulating property and have a hardness approximately equivalent to the hardnesses of glass epoxy resin and polyimide resin.

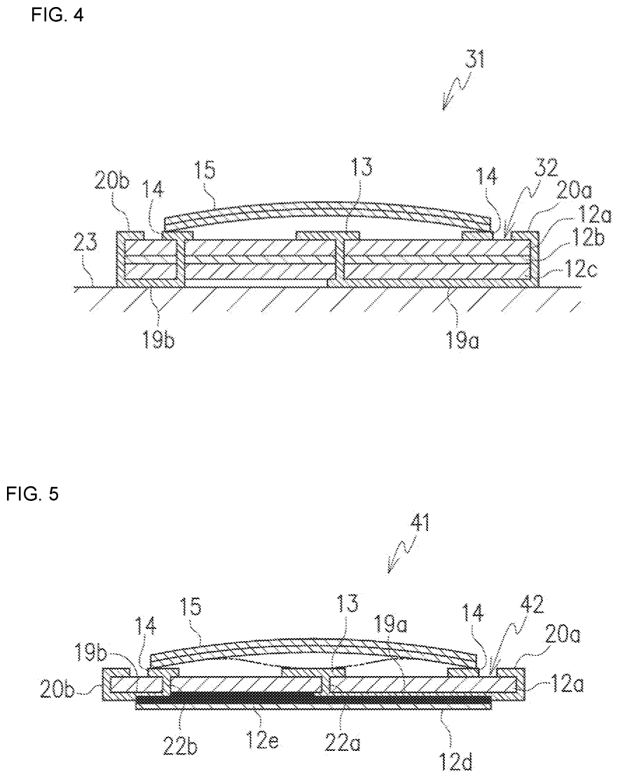

FIG. 4 illustrates a switch unit 31 according to the second embodiment of the present application. In the switch unit 31, a substrate 32 includes: a pair of an upper hard layer 12a and a lower hard layer 12c; and a soft layer 12b, which is held between the pair of hard layers 12a and 12c. That is, as illustrated in FIG. 4, in the second embodiment, the substrate 32 has a three-layer structure made up of the hard layers 12a and 12c and the soft layer 12b. The hard layers 12a and 12c and the soft layer 12b have approximately same shapes.

Similarly to the substrate 12 according to the first embodiment, the soft layer 12b is provided under the first contact point 13; in the second embodiment, the soft layer 12b is provided immediately under the first contact point 13. This configuration enables the soft layer 12b to absorb the contact sound and the amplification sound, keeping the switch unit 31 noiseless. Further, in the switch unit 31, the pair of upper and lower hard layers 12a and 12c receive the press of the conduction spring member 15 to provide excellent click sensitivity.

Also, a hard layer, 12c, is also provided on the lower surface of the soft layer 12b. This improves the workability with which the switch unit 31 is mounted on the mount substrate 23, such as a mother board. Further, at least one of the hard layer 12a and the hard layer 12c may be thinner. Similarly to the first embodiment, the pair of hard layers 12a and 12c and the soft layer 12b may be joined to each other by: radiating ultrasonic or laser to their joint surfaces; or via bonding layers such as binders or bonding sheets (neither of which is illustrated) of epoxy resin or acrylic resin.

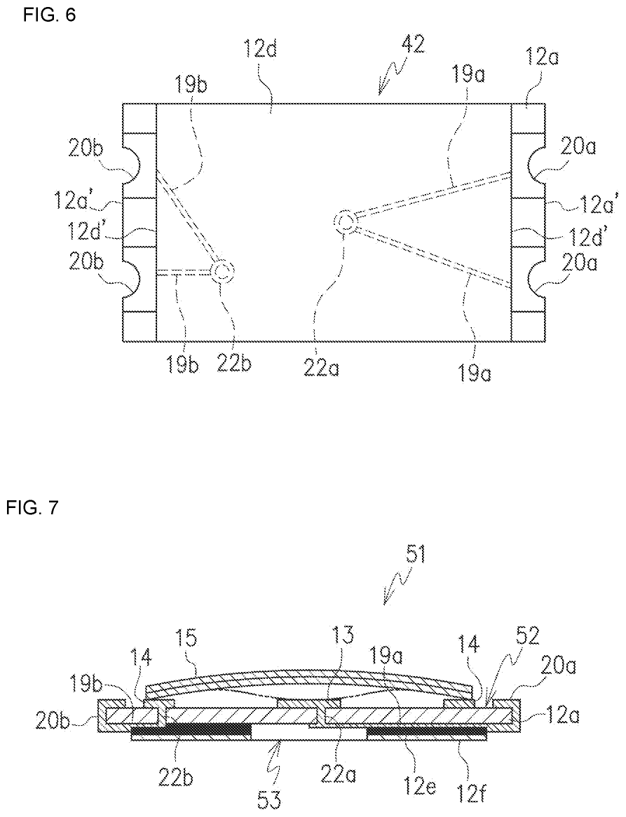

FIGS. 5 and 6 illustrate a switch unit 41 according to the third embodiment of the present application. In the switch unit 41, a substrate 42 includes an upper hard layer 12a and a lower soft layer 12d. That is, as illustrated in FIG. 5, the substrate 42 according to the third embodiment has a two-layer structure made up of the hard layer 12a and the soft layer 12d. On the lower surface of the hard layer 12a, a first wiring pattern 19b is provided. The first wiring pattern 19b is electrically connected to the first contact point 13 via the first through-hole electrode 22a, which penetrates the hard layer 12a. Also, on the lower surface of the hard layer 12a, a second wiring pattern 19b is provided. The second wiring pattern 19b is electrically connected to the second contact point 14 via the second through-hole electrode 22b, which penetrates the hard layer 12a.

As illustrated in FIG. 6, the first wiring pattern 19b connects the first through-hole electrode 22a of the first contact point 13 to the first external electrode 20a, which is provided at one end portion of the substrate 42. Also, the second wiring pattern 19b connects the second through-hole electrode 22b of the second contact point 14 to the second external electrode 20b, which is provided at another end portion of the substrate 42. In the third embodiment, the first wiring pattern 19b and the second wiring pattern 19b are thin and linear conduction patterns. With this configuration, the area of the first wiring pattern 19b and the second wiring pattern 19b combined is quite smaller than the area of the soft layer 12d. It is to be noted that the wiring patterns in the first embodiment and the second embodiment may be thin and linear conduction patterns, similarly to the third embodiment.

In the third embodiment, in a plan view, the outer circumference of the first contact point 13 is located at a position inner than the right and left outer circumferences 12d′ of the soft layer 12d. Also, the right and left outer circumferences 12d′ of the soft layer 12d are located at positions inner than the right and left outer circumferences 12a′ of the hard layer 12a. More specifically, the right and left outer circumferences 12d′ of the soft layer 12d are located at positions close to and inner than the first external electrode 20a and the second external electrode 20b, which are provided at both end portions of the hard layer 12a. Alternatively, the right and left outer circumferences 12d′ of the soft layer 12d may be located at positions further inner than the first external electrode 20a and the second external electrode 20b; for example, inner than the second contact point 14. The soft layer 12d is joined to the lower surface of the hard layer 12a via a bonding layer 12e, which is a bonding material or a bonding sheet such as epoxy resin and acrylic resin.

The switch unit 41 according to the third embodiment is similar to the switch unit 11 and the switch unit 31 in that the soft layer 12d provided immediately under the first contact point 13 absorbs the contact sound and the amplification sound, ensuring noiselessness of the switch unit 41. Also, the hard layer 12a receives the press of the conduction spring member 15 to enable the switch unit 41 to provide excellent click sensitivity. Also as illustrated in FIG. 5, the soft layer 12d covers a lower portion of the hard layer 12a including the first wiring pattern 19b and the second wiring pattern 19b. With this configuration, the switch unit 41 ensures that the soft layer 12d effectively absorbs the contact sound and the amplification sound without undermining the click sensitivity intended to be felt when the conduction spring member 15 is pressed.

Further, in the third embodiment, the first wiring pattern 19b and the second wiring pattern 19b are linear patterns which are narrow in width. The wiring pattern area of the first wiring pattern 19b and the second wiring pattern 19b combined is quite smaller than the area of the soft layer 12d. This eliminates or minimizes a situation in which contact sound and amplification sound are generated by the first wiring pattern 19b and the second wiring pattern 19b, which are hard patterns made of copper foil.

In the third embodiment, the first wiring pattern 19b and the second wiring pattern 19b are narrow in width linear patterns so that a shortest connection distance is realized between the first through-hole electrode 22a and the first external electrode 20a and between the second through-hole electrode 22b and the second external electrode 20b. It is possible, however, to set the wiring patterns in any other desired manner in terms of thickness, shape, and area. From the viewpoint of the switch unit 41's noiselessness, however, the wiring pattern area of the first wiring pattern 19b and the second wiring pattern 19b combined is preferably smaller than the area of the soft layer 12d.

FIG. 7 illustrates a switch unit 51 according to the fourth embodiment of the present application. The switch unit 51 has a configuration approximately the same as the configuration of the switch unit 41 according to the third embodiment except that a through hole 53 is formed at the center of a soft layer 12f In the fourth embodiment, the soft layer 12f has the through hole 53. The area of the through hole 53 is larger than the area of the first contact point 13. However, there is no particular limitation to how large the area of the through hole 53 is. For example, the area of the through hole 53 may be smaller than the area of the first contact point 13.

The through hole 53 is preferably positioned immediately under the first contact point 13. The shape of the through hole 53 may be a circular shape or a polygonal shape such as a rectangle. In the fourth embodiment, the substrate 52 has a two-layer structure made up of the hard layer 12a and the soft layer 12f, and the through hole 53 of the soft layer 12f is provided immediately under the first contact point 13. This configuration enables the soft layer 12f to absorb the contact sound and the amplification sound. Further, the contact sound and the amplification sound can be externally released through the through hole 53. This increases the reliability with which noiselessness of the switch unit 51 is ensured. It is to be noted that the soft layer 12f is joined to the lower surface of the hard layer 12a via the bonding layer 12e.

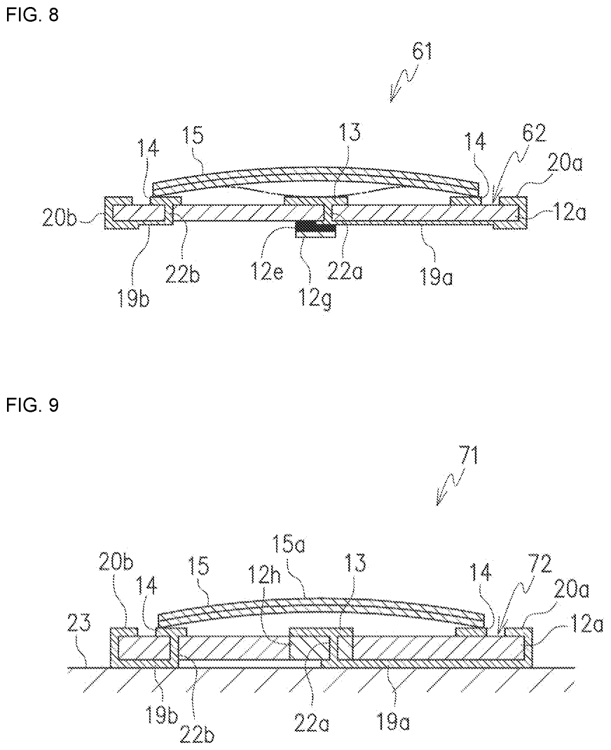

FIG. 8 illustrates a switch unit 61 according to the fifth embodiment of the present application. In the switch unit 61, a substrate 62 includes: a hard layer 12a, which is provided at an upper portion of the substrate 62; and a soft layer 12g, which is provided at a lower portion of the substrate 62. That is, as illustrated in FIG. 8, the substrate 62 according to the fifth embodiment has a two-layer structure made up of the hard layer 12a and the soft layer 12g. The switch unit 61 has a configuration approximately the same as the configuration of the switch unit 41 according to the third embodiment except that in a plan view, the outer circumference of the soft layer 12g is located at a position inner than the outer circumference of the first contact point 13.

As illustrated in FIG. 8, even though the soft layer 12g is smaller than the first contact point 13, by providing the soft layer 12g immediately under the first contact point 13, the soft layer 12g is able to reliably absorb the contact sound and the amplification sound. The shape of the soft layer 12g may be a circular shape or a polygonal shape such as a rectangle. Thus, the substrate 62 has a two-layer structure made up of the hard layer 12a and the soft layer 12g, and the soft layer 12g is provided immediately under the first contact point 13. This configuration enables the soft layer 12g to absorb the contact sound and the amplification sound, ensuring noiselessness of the switch unit 61. The soft layer 12g is joined to the lower surface of the hard layer 12a via the bonding layer 12e. It is to be noted that in a plan view, a size of the outer circumference of the soft layer 12g may be identical to a size of the outer circumference of the first contact point 13.

FIG. 9 illustrates a switch unit 71 according to the sixth embodiment of the present application. As illustrated in FIG. 9, in the switch unit 71, a substrate 72 includes: a soft layer 12h, which is in contact with the lower surface of the first contact point 13; and a hard layer 12a, which is in contact with the lower surface of the second contact point 14 and provided around the soft layer 12h. In the switch unit 71, since the soft layer 12h is provided immediately under the first contact point 13, the soft layer 12h reliably absorbs the contact sound and the amplification sound.

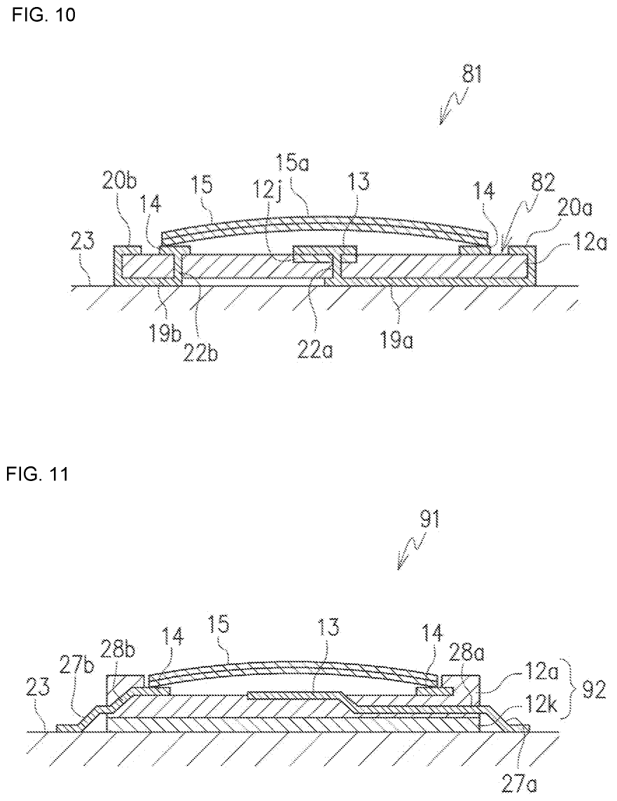

FIG. 10 illustrates a switch unit 81 according to the seventh embodiment of the present application. As illustrated in FIG. 10, in the switch unit 81, a substrate 82 includes: a soft layer 12j, which is in contact with the lower surface of the first contact point 13; and a hard layer 12a, which is in contact with the lower surface of the second contact point 14 and provided around the soft layer 12j. The soft layer 12j is thinner than the hard layer 12a. In the switch unit 81, since the soft layer 12j is provided immediately under the first contact point 13, the soft layer 12j reliably absorbs the contact sound and the amplification sound.

The switch units 11, 31, 41, 51, 61, 71, and 81 are also applicable to switch devices using lead frames. FIG. 11 illustrates a switch unit 91 according to the eighth embodiment of the present application. The switch unit 91 includes a lead frame. The switch unit 91 includes a substrate 92, a first contact point 13, a second contact point 14, a conduction spring member 15, a first external electrode 27a, a second external electrode 27b, a first connection electrode 28a, and a second connection electrode 28b. The substrate 92 includes a hard layer 12a and a soft layer 12k, which is provided on the lower surface of the hard layer 12a.

The first contact point 13 is provided on the upper surface of the substrate 92 and above the soft layer 12k. The first contact point 14 is provided on the upper surface of the substrate 92 and around the first contact point 14. The conduction spring member 15 is provided above the first contact point 13 in a non-contact state with the first contact point 13, and in a contact state with the second contact point 14. And the conduction spring member 15 is elastically deformable into contact with the first contact point 13 to make a conduction between the first contact point 13 and the second contact point 14. The first external electrode 27a and the second external electrode 27b are provided at end portions of the substrate 92.

The first connection electrode 28a is provided at an inside portion of the substrate 92, and electrically connects the first contact point 13 and the first external electrode 27a to each other. The second connection electrode 28b is provided at an inside portion of the substrate 92, and electrically connects the second contact point 14 and the second external electrode 27b to each other. The switch unit 91 is mounted on the mount substrate 23, such as a mother board, via the soft layer 12k. In the switch unit 91, since the soft layer 12k is provided under the first contact point 13, the soft layer 12k reliably absorbs the contact sound and the amplification sound.

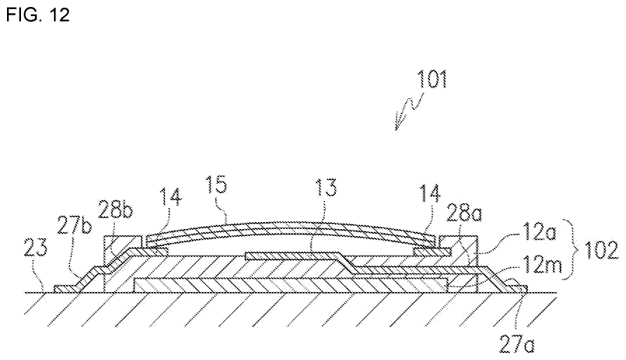

FIG. 12 illustrates a switch unit 101 according to the ninth embodiment of the present application. The switch unit 101 includes a lead frame. The switch unit 101 has a configuration approximately the same as the configuration of the switch unit 91 according to the eighth embodiment except that the hard layer 12a also exists around a soft layer 12m. The substrate 102 includes the hard layer 12a and the soft layer 12m, which is provided on the lower surface of the hard layer 12a. In the switch unit 101, since the soft layer 12m is provided under the first contact point 13, the soft layer 12m reliably absorbs the contact sound and the amplification sound.

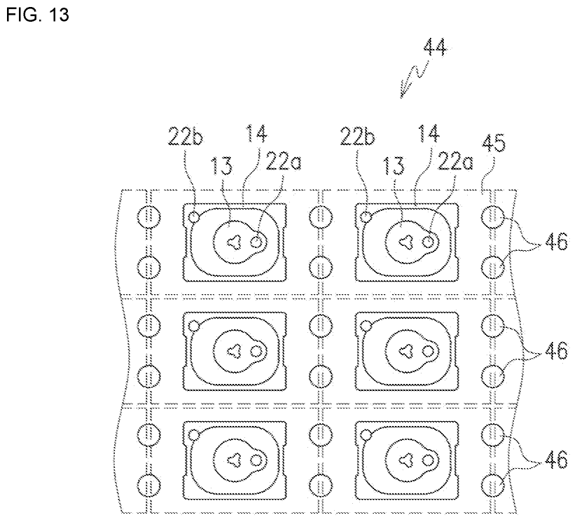

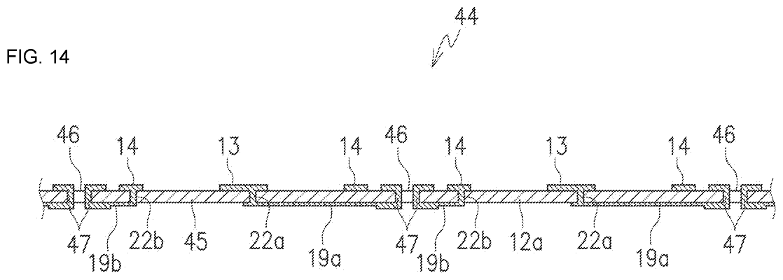

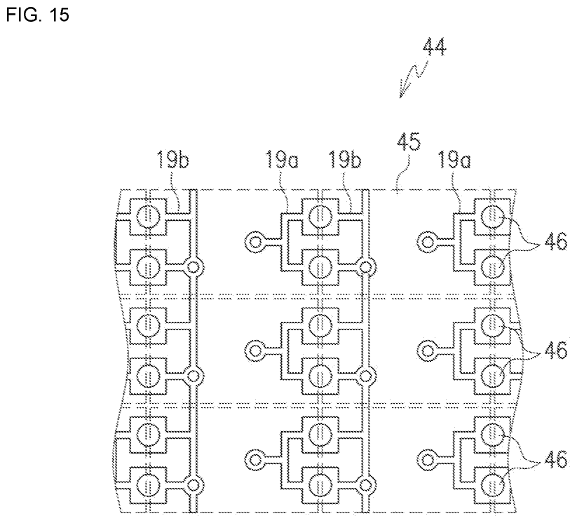

By referring to FIGS. 13 to 17, description will be made with regard to a method for producing a switch substrate 43 using an aggregation method. FIG. 13 illustrates the upper surface of an aggregate switch substrate member 44, which is a material of the switch substrate 43, which constitutes the switch unit 41 according to the third embodiment. FIG. 14 is a sectional view of the aggregate switch substrate member 44. FIG. 15 illustrates the lower surface of the aggregate switch substrate member 44. The aggregate switch substrate member 44 includes an aggregate substrate 45, a plurality of first contact points 13, a plurality of second contact points 14, a plurality of first through-hole electrodes 22a, a plurality of second through-hole electrodes 22b, a plurality of through holes 46, a plurality of first wiring patterns 19a, and a plurality of second wiring patterns 19b.

The aggregate substrate 45 is made up of a hard layer 12a. The plurality of first contact points 13 are provided on the upper surface of the aggregate substrate 45. The plurality of second contact points 14 are provided on the upper surface of the aggregate substrate 45 and provided around the respective first contact points 13. The plurality of first through-hole electrodes 22a are provided at an inside portion of the aggregate substrate 45 and electrically connected to the respective first contact points 13. The plurality of second through-hole electrodes 22b are electrically connected to the respective second contact points 14.

The plurality of through holes 46 extend between the upper surface and the lower surface of the aggregate substrate 45, and conduction layers 47 are provided on the side surfaces of the through holes 46. The plurality of first wiring patterns 19a are provided on the lower surface of the aggregate substrate 45 and electrically connected to the respective conduction layers 47 and the respective first through-hole electrodes 22a. The plurality of second wiring patterns 19b are electrically connected to the respective conduction layers 47 and the respective second through-hole electrodes 22b. The method for producing the switch substrate 43 includes a forming step and a cutting step.

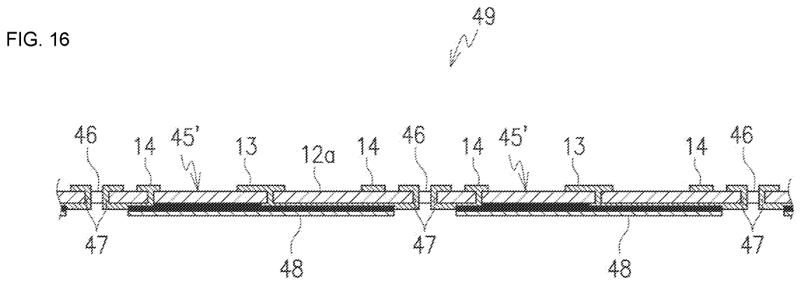

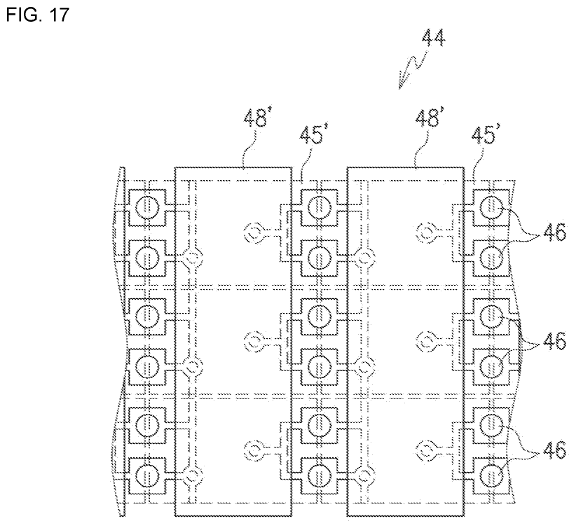

In the forming step, an aggregate switch substrate 49 is obtained by forming a soft layer 48 on the lower surface of the aggregate switch substrate member 44 in such a manner that the soft layer 48 covers a portion located at least immediately under the plurality of first contact points 13 and does not cover the plurality of through holes 46. FIG. 16 is a sectional view of the aggregate switch substrate 49 as of the time after the forming step. FIG. 16 is a sectional view of the aggregate switch substrate 49 as of the time after the forming step. FIG. 17 illustrates the lower surface of the aggregate switch substrate 49 as of the time after the forming step. In the cutting step, individual switch substrates 43 are obtained by cutting the aggregate switch substrate 49 along the lattice-shaped broken lines illustrated in FIG. 17 and through at least the plurality of through holes 46. By the cutting step, the through hole 46 is divided into the first external electrode 20a and the second external electrode 20b.

The switch substrate 43 thus obtained includes: a substrate 45′, which includes the hard layer 12a and the soft layer 48; the first contact point 13; the second contact point 14; the first through-hole electrode 22a; the second through-hole electrode 22b; the first external electrode 20a; the second external electrode 20b; the first wiring pattern 19a; and the second wiring pattern 19b. The forming step may include a step of bonding, to the lower surface of the aggregate switch substrate member 44, a plurality of soft plates 48′ in a stripe arrangement. The soft plates 48′ are made up of the soft layer 48. By this step, the soft layer 48 is efficiently formed on the lower surface of the aggregate substrate 45, which is made up of the hard layer 12a.

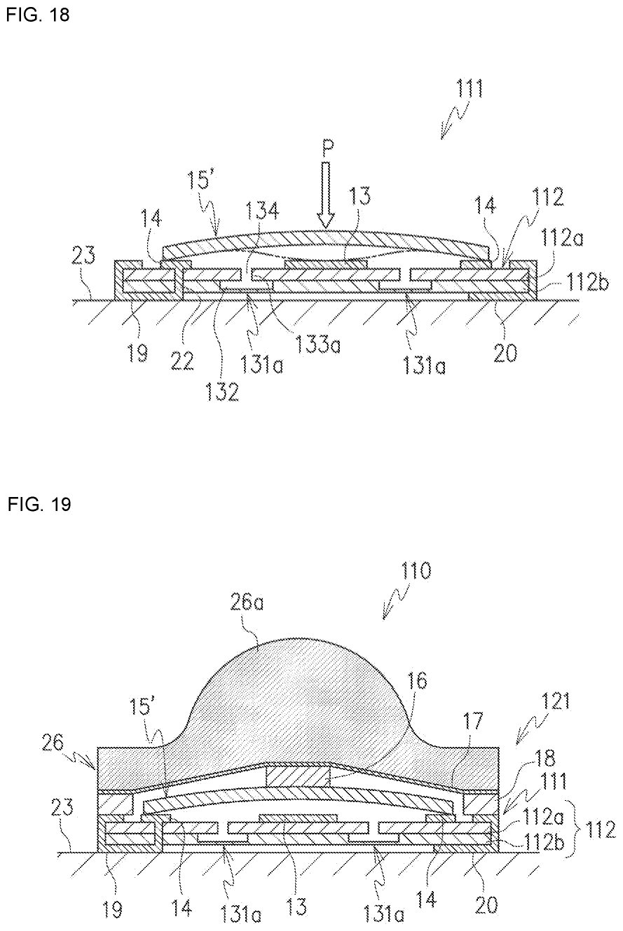

FIG. 18 illustrates a switch unit 111 according to the tenth embodiment of the present application. The switch unit 111 includes a substrate 112, a first contact point 13, a second contact point 14, and a conduction spring member 15′. The substrate 112 is mounted on the mount substrate 23, such as a mother board. The substrate 112 includes a first substrate member 112a and a second substrate member 112b. On the back surface of the second substrate member 112b, a pair of external electrodes 19 and 20 are formed.

The substrate 112 includes: a cavity 132, which is formed inside the substrate 112; an opening 134, which is formed on the upper surface of the substrate 112, and a connection hole 133a, which connects the opening 134 and the cavity 132 to each other. The first contact point 13 is provided on the upper surface of the substrate 112. The second contact point 14 is provided around the first contact point 13. The conduction spring member 15′ is provided above the first contact point 13 in a non-contact state with the first contact point 13 and in a contact state with the second contact point 14. And the conduction spring member 15′ is elastically deformable into contact with the first contact point 13 to make a conduction between the first contact point 13 and the second contact point 14. The second contact point 14 is electrically connected to the external electrode 19 via a through hole 22, which penetrates the substrate 112.

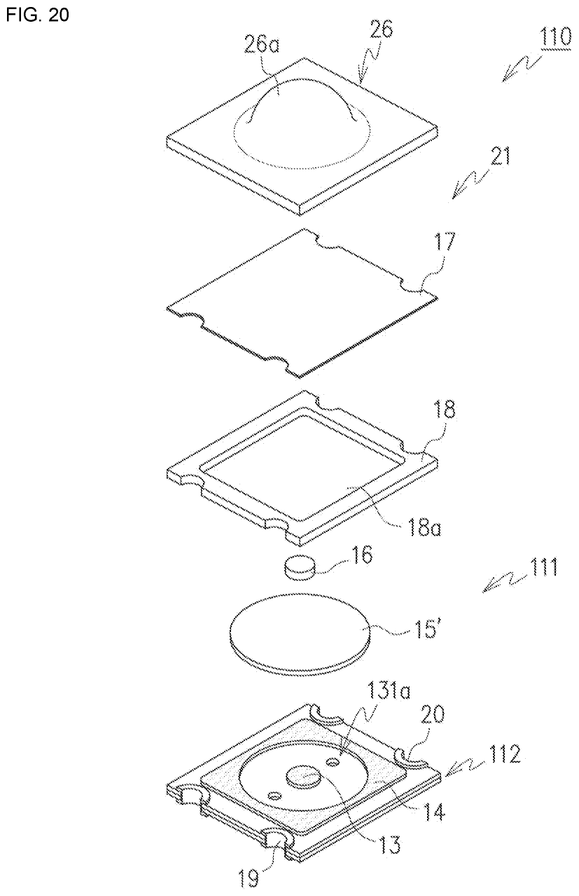

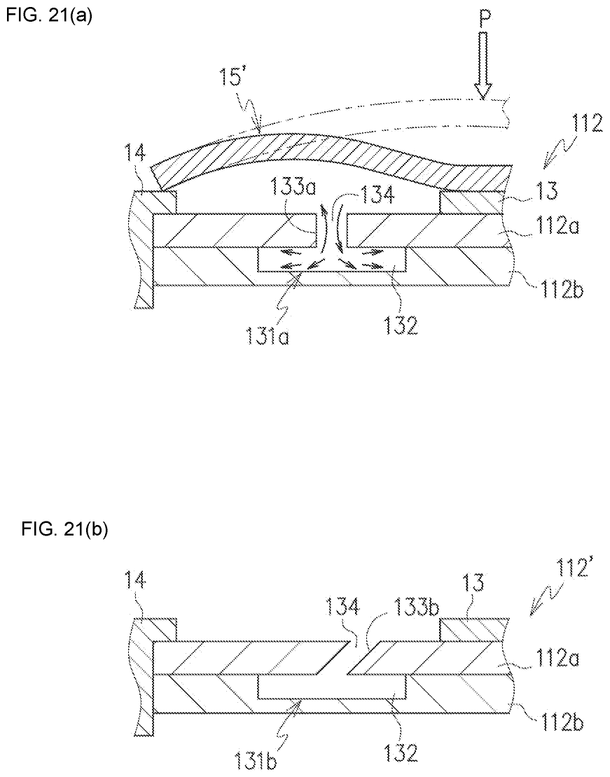

FIG. 19 illustrates a sectional structure of a switch device 110, which includes the switch unit 111. FIG. 20 illustrates an exploded structure of the switch device 110. FIG. 21(a) is a partial sectional view of the substrate 112, which includes the opening 134, the connection hole 133a, and the cavity 132. FIG. 21(b) is a partial sectional view of a substrate 112′, which is a modification of the substrate 112 and includes the opening 134, a connection hole 133b, and the cavity 132. The configuration of the switch device 110 from the pressing element 16 up is the same as the configuration of the switch device 10 from the pressing element 16 up. The switch device 10 includes the switch unit 11 according to the first embodiment. Therefore, the configuration of the switch device 110 from the pressing element 16 up will not be elaborated upon here. The shape of the conduction spring member 15′ is a circular dome shape.

As illustrated in FIG. 19, the substrate 112 includes the first substrate member 112a and the second substrate member 112b, which is provided under the first substrate member 112a. The first contact point 13 and the second contact point 14 are provided on the upper surface of the first substrate member 112a. The opening 134 and the connection hole 133a are formed in the first substrate member 112a, and the cavity 132 is formed in the second substrate member 112b. The cavity 132 has such a depth that the cavity 132 does not penetrate the second substrate member 112b. The connection hole 133a penetrates the first substrate member 112a.

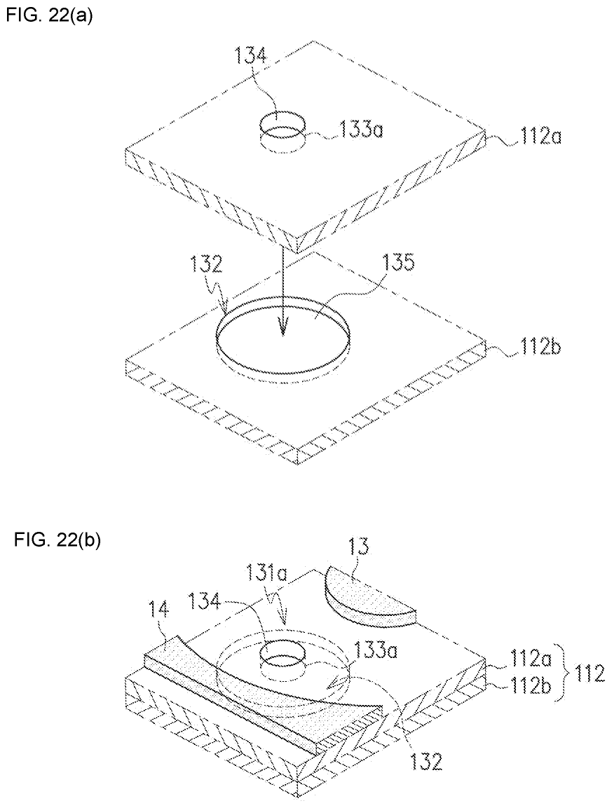

FIG. 22(a) illustrates an exploded structure of part of the first substrate member 112a and the second substrate member 112b. FIG. 22(b) illustrates part of the substrate 112. As illustrated in FIG. 22(b), the opening 134 is formed on the upper surface of the first substrate member 112a in such a manner that the opening 134 circumvents the first contact point 13 and the second contact point 14. Then, as illustrated in FIG. 22(a), the first substrate member 112a and the second substrate member 112b are joined to each other in such a manner that the opening 134 overlaps an opening 135 of the cavity 132.

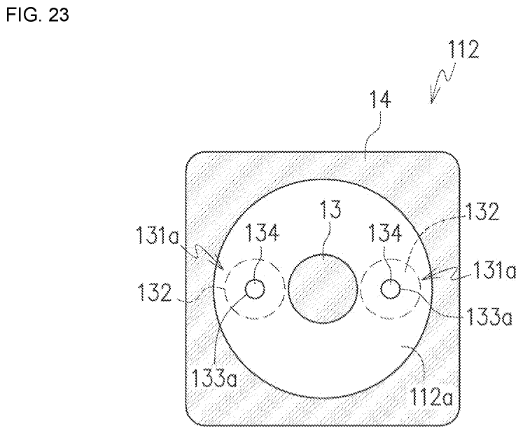

FIG. 23 illustrates the upper surface of part of the substrate 112. As illustrated in FIG. 23, the maximum value of the sectional area of the connection hole 133a parallel to the upper surface of the substrate 112 is smaller than the maximum value of the sectional area of the cavity 132 parallel to the upper surface of the substrate 112. That is, the sectional area in a plan view of the connection hole 133a is smaller than the sectional area in a plan view of the cavity 132. The length of the connection hole 133a is determined by the thickness of the first substrate member 112a.

The opening 134, the connection hole 133a, and the cavity 132 constitute a silencer 131a. Also, the opening 134, the connection hole 133b, and the cavity 132 constitute a silencer 131b. The silencer 131a is formed based on the principle of a Helmholtz resonator. An operation of the silencer 131a will be described below by referring to FIG. 21(a). By a switching operation, the conduction spring member 15 is brought into contact with the first contact point 13, generating a sound. This sound is accompanied by a puff of air, and the air is guided through the narrow opening 134 and the connection hole 133a and pressed into the cavity 132. Pressed in the cavity 132, the air has nowhere to go further and is pressed back toward the opening 134. Pressed back out of the opening 134, the air turns into negative pressure and is pressed again toward the cavity 132 through the opening 134. By repeating this set of movements, an air friction is generated in the connection hole 133a and causes the contact sound to attenuate.

The connection hole 133a of the silencer 131a illustrated in FIG. 22 penetrates the first substrate member 112a in a direction perpendicular to the upper surface of the first substrate member 112a. Alternatively, the connection hole 133b may be formed in a direction inclined relative to the upper surface of the first substrate member 112a, similarly to the silencer 131b illustrated in FIG. 21(b). Thus, by forming the inclined connection hole 133b, the ventilation passage to the cavity 132 can be made longer. This ensures that a thin material can be employed as the first substrate member 112a, making the substrate 112 smaller in thickness as a whole.

The first substrate member 112a and the second substrate member 112b may be joined to each other by radiating ultrasonic and/or laser to their joint surfaces after positioning the cavity 132 and the connection hole 133a. Also, the first substrate member 112a and the second substrate member 112b may be joined to each other via a binder or a bonding sheet (neither of which is illustrated) of epoxy resin or acrylic resin. The first contact point 13 and the second contact point 14 are formed by patterning such as etching of an electrode film formed on the upper surface of the first substrate member 112a.

Also, the first contact point 13 and the second contact point 14 are electrically connected to a first external electrode 119 and a second external electrode 20 through the through hole 122, which penetrates the substrate 112. The first external electrode 119 and the second external electrode 20 are formed on the lower surface of the second substrate member 112b. The first external electrode 119 and second external electrode 20 are formed by patterning such as etching of an electrode film formed on the lower surface of the second substrate member 112b.

The connection hole 133a is formed by a quantity corresponding to the quantity of the cavity 132, and each one cavity 132 is connected to a corresponding one connection hole 133a. In one example, a pair of silencers 131a are provided at positions where the silencers 131a face each other across the first contact point 13, where contact sound is generated. Each silencer 131a is independently formed and made up of one cavity 132 and one connection hole 133a. The cavities 132 may be identical to each other in terms of capacity. The connection holes 133a may be identical to each other in terms of the length. The openings 134 may be identical to each other in terms of the diameter. While the tenth embodiment is an example in which a pair of silencers 131a are provided, at least one silencer 131a suffices to decrease the contact sound generated by the contact between the first contact point 13 and the conduction spring member 15. Further, by providing three or more silencers 131a along the circumference of the first contact point 13, the contact sound generated by the contact between the first contact point 13 and the conduction spring member 15 is further decreased.

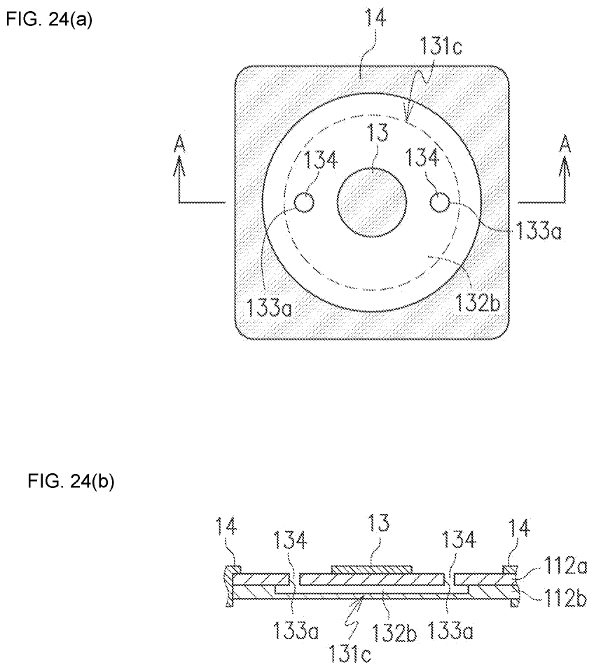

FIG. 24(a) illustrates the upper surface of part of the substrate of a switch unit according to the eleventh embodiment. FIG. 24(b) is an A-A line sectional view of the part of the substrate illustrated in FIG. 24(a). In a silencer 131c according to the eleventh embodiment, the connection hole 133a is larger in quantity than the cavity 132b, and a plurality of connection holes 133a are connected to one cavity 132b. The silencer 131c illustrated in FIGS. 24(a) and 24(b) is made up of: a large one cavity 132b, which is formed immediately under the first contact point 13; and two connection holes 133a, which are connected to the cavity 132b.

The first substrate member 112a according to the eleventh embodiment is the same as the first substrate member 112a according to the tenth embodiment. By providing a larger depression at a center portion of the second substrate member 112b, the area of the circular cavity 132b is made larger than the area of the first contact point 13. Thus, by increasing the capacity of the cavity 132b, a larger amount of inflowing air is pressed into the cavity 132b through the plurality of connection holes 133a, and the air pressed into the cavity 132b causes a larger level of vibration to be generated. This decreases the sound emitted externally from the cavity 132b through each connection hole 133a. It is to be noted that each connection hole 133a according to the eleventh embodiment may be formed in a direction perpendicular or inclined relative to the upper surface of the first substrate member 112a, similarly to the connection holes 133a and 133b according to the tenth embodiment. The connection holes according to the twelfth to fifteenth embodiments may also be formed in a direction perpendicular or inclined relative to the upper surface of the first substrate member.

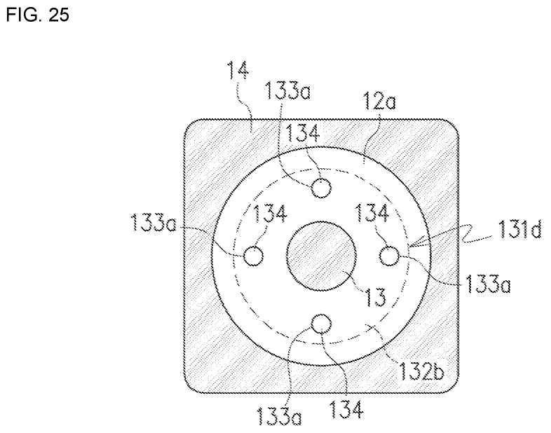

FIG. 25 illustrates the upper surface of part of the substrate of a switch unit according to the twelfth embodiment. As illustrated in FIG. 25, a silencer 131d according to the twelfth embodiment includes one large circular cavity 132b, a plurality of (three or more) connection holes 133a, and a plurality of (three or more) openings 134. It is to be noted that there is no particular limitation to the positions of the connection holes 133a and the openings 134. In the twelfth embodiment, four openings 134 are provided at equal intervals in a circular arrangement over the cavity 132b. Thus, by providing a large quantity of connection holes 133a and openings 134 around the first contact point 13, the contact sound emitted from the first contact point 13 and around thereof can be decreased over a wider range.

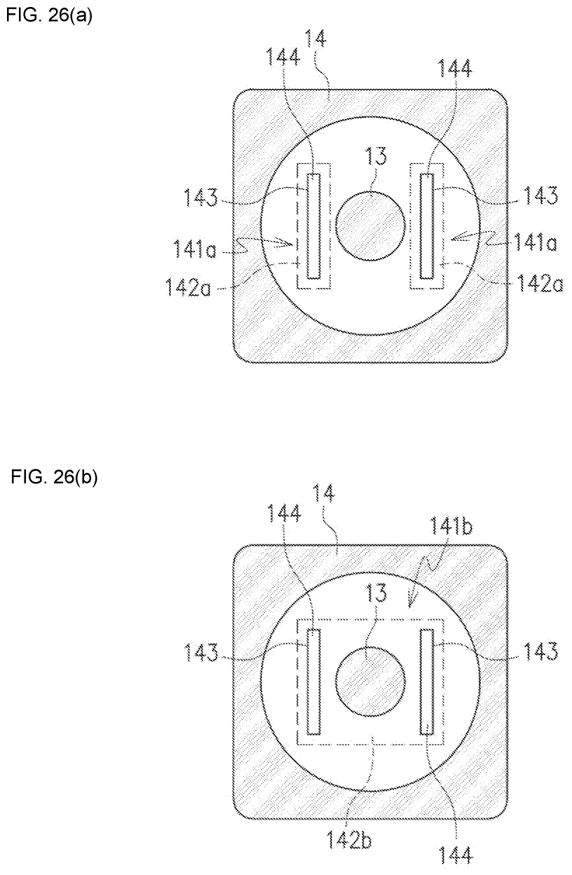

FIG. 26(a) illustrates the upper surface of part of the substrate of a switch unit according to the thirteenth embodiment. In the thirteenth embodiment, a silencer 141a includes: a linearly extending opening 144; a connection hole 143, which penetrates the first substrate member 112a and has a linear shape; and a cavity 142a, which has a planar shape surrounding the outer shape of the connection hole 143. The silencer 141a is provided in the form of a pair each provided on one and the other sides of the first contact point 13, where contact sound is generated. While FIG. 26(a) illustrates an example in which two silencers 141a are provided, at least one silencer 141a suffices to decrease the contact sound generated by the contact between the first contact point 13 and the conduction spring member 15. By providing three or more silencers 141a along the circumference of the first contact point 13, the contact sound generated by the contact between the first contact point 13 and the conduction spring member 15 is further decreased.

FIG. 26(b) illustrates the upper surface of part of the substrate of a switch unit according to the fourteenth embodiment. In the fourteenth embodiment, a silencer 141b includes one larger quadrangular cavity 142b and two linear connection holes 143, which are connected to the cavity 142b. The cavity 142b is formed by providing a larger quadrangular depression at a center portion of the second substrate member 112b. Thus, by increasing the capacity of the cavity 142b, the amount of air pressed into the cavity 142b through each connection hole 143 increases, and the air pressed into the cavity 142b causes a larger level of vibration to be generated. This decreases the sound emitted externally through each connection hole 143.

In the fourteenth embodiment, it is possible to provide three or more connection holes 143 surrounding the first contact point 13, with the planar space defined in the cavity 142b taken into consideration. Thus, by providing a plurality of connection holes 143, the contact sound generated by the contact between the first contact point 13 and the conduction spring member 15 is further decreased. It is to be noted that the cavity 142b may have an area of space large enough to be connected to more than one connection hole 143. Therefore, the shape of the cavity 142b will not be limited to a quadrangular shape but may be any other polygonal shape than a quadrangular shape or may be a circular shape.

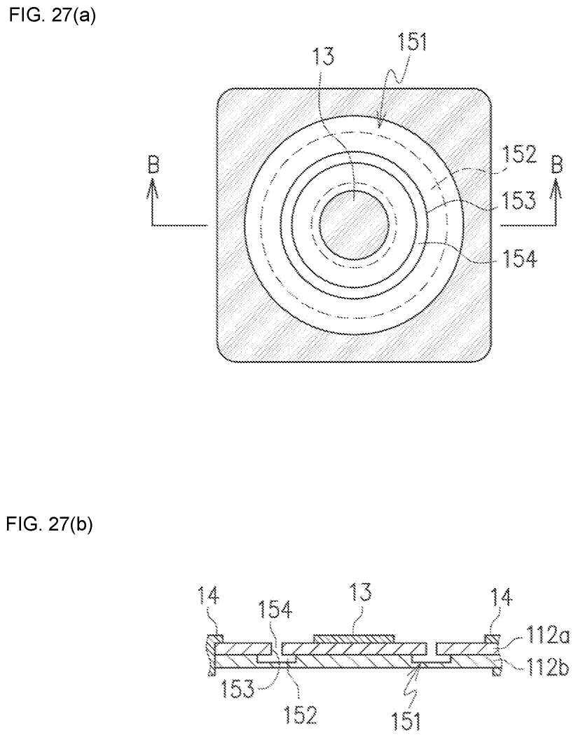

FIG. 27(a) illustrates the upper surface of part of the substrate of a switch unit according to the fifteenth embodiment. FIG. 27(b) is a B-B line sectional view of the part of the substrate illustrated in FIG. 27(a). In the fifteenth embodiment, a silencer 151 includes: a ring-shaped cavity 152, which is provided along the outer circumference of the first contact point 13 and has a predetermined circumferential width; and a connection hole 153, which is connected to the cavity 152 approximately at the center of the opening width on the circumference of the cavity 152. A ring-shaped opening 154 is connected to the connection hole 153 and formed on the upper surface of the first substrate member 112a. The silencer 151 is provided such that the silencer 151 surrounds the outer circumference of the first contact point 13. This enables the silencer 151 to omni-directionally absorb the contact sound emitted from the first contact point 13. As a result, the contact sound is efficiently decreased, without a leakage of the contact sound to outside the silencer 151.

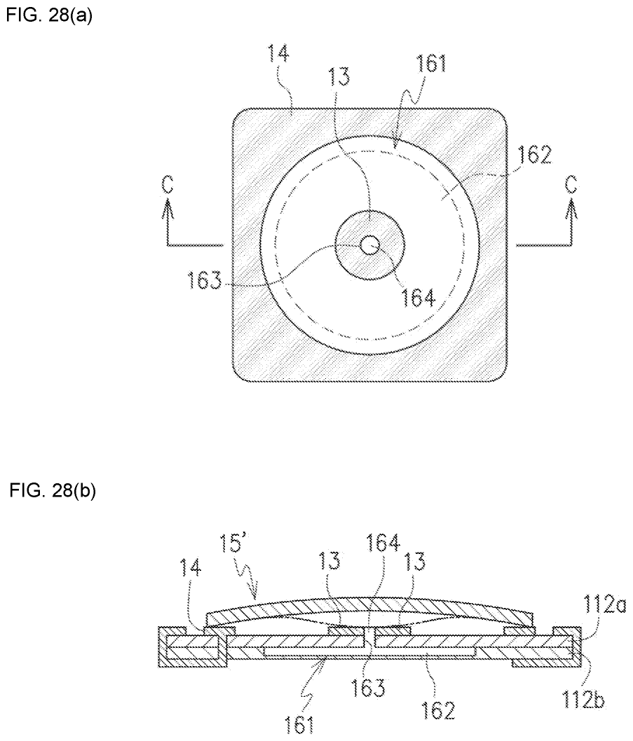

FIG. 28(a) illustrates the upper surface of part of the substrate of a switch unit according to the sixteenth embodiment. FIG. 28(b) is a C-C line sectional view of the part of the substrate illustrated in FIG. 28(a). In the sixteenth embodiment, the first contact point 13 has a ring shape provided with a circular hole at a center portion of the ring shape. On the upper surface of the first substrate member 112a, an opening 164 is formed. The opening 164 has a size corresponding to this circular hole.

A cavity 162 is a spacious circular cavity and formed immediately under the first contact point 13. In the first substrate member 112a, a connection hole 163 is provided. The connection hole 163 connects the cavity 162 and the opening 164 to each other. In a silencer 161 according to the fifteenth embodiment, the ratio of the area of the cavity 162 to the area of the second substrate member 112b as a whole is large. With this configuration, the silencer 161 is more suitable for a small-size substrate in which the space between the first contact point 13 and the second contact point 14 is small.

In all the tenth to sixteenth embodiments, a two-layer substrate made up of the first substrate member 112a and the second substrate member 112b is used. Alternatively, it is possible to use a three-layer substrate formed by mounting a third substrate member 112c on a lower portion of the second substrate member 112b. In this case, a cavity 172 is formed in the second substrate member 112b, and the lower surface of the cavity 172 is defined by the upper surface of the third substrate member 112c. A through hole serving as the cavity 172 is defined by the second substrate member 112b, and the third plate 12c is provided under the cavity 172. This configuration ensures that a silencer 171 is easily formed including an opening 174, a connection hole 173, and the bottomed cavity 172.

It is preferable that the cavity 172 and the connection hole 173, which constitute the silencer 171, are sealed. In light of this, the materials of the first substrate member 112a, the second substrate member 112b, and the third substrate member 112c are preferably high-density hard materials such as glass epoxy substrate (FR-4). Using such hard members prevents the conduction spring member 15 from being kept in depressed state toward the first contact point 13, and provides a moderate level of click sensitivity. This improves the switch unit's switching accuracy.

In conventional noiseless switch units, a shock-absorbing material is provided on the substrate or the substrate itself is made of a noiseless material, in order to alleviate the contact sound caused by switching. In a switch unit according to an embodiment of the present application, even though the switch unit is small and thin, a through hole or a depression having different opening widths are formed in the substrate having a multilayer structure such as a two-layer or three-layer structure. This ensures that the switch unit provides a silencing effect that is based on a Helmholtz resonator principle, which promotes positive absorption of sounds. The switch units according to the tenth to sixteenth embodiment and the switch units according to other embodiments including a three-layer substrate are also applicable to switch devices using lead frames.

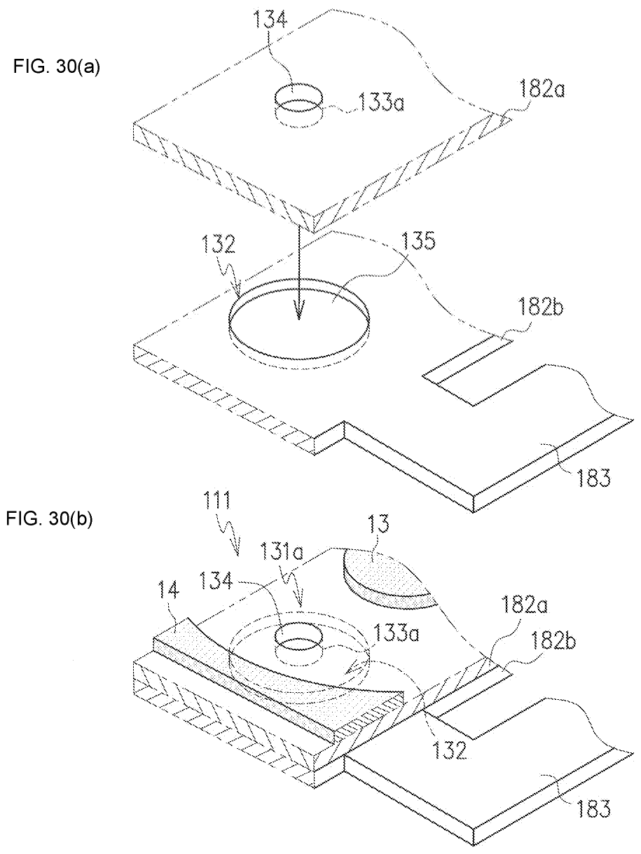

It is possible to: form a large-size aggregate first substrate in which a plurality of first substrate members 112a can be formed; form a large-size aggregate second substrate in which a plurality of second substrate members 112b can be formed; stack the aggregate first substrate on the aggregate second substrate; and subject the substrate to dicing along a predetermined region. As a result, substrates 112 corresponding to respective switch units 111 according to the tenth embodiment can be formed collectively. The first substrate member 112a and the second substrate member 112b may be flexible substrates. An example is illustrated in FIGS. 30(a) and 30(b).

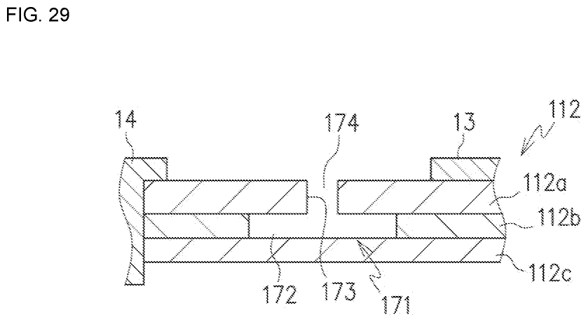

In this example, an aggregate first substrate 182a has a plurality of connection holes 133a, and an aggregate second substrate 182b has a plurality of cavities 132 and a lead portion 183. The aggregate first substrate 182a is joined on the aggregate second substrate 182b. The aggregate first substrate 182a and the aggregate second substrate 182b that have been joined to each other are cut from the lead portion 183 and divided into regions of individual switch units 111, which is not illustrated. It is to be noted that this aggregate substrate may also be used to form the substrate having the layer structure illustrated in FIG. 29.

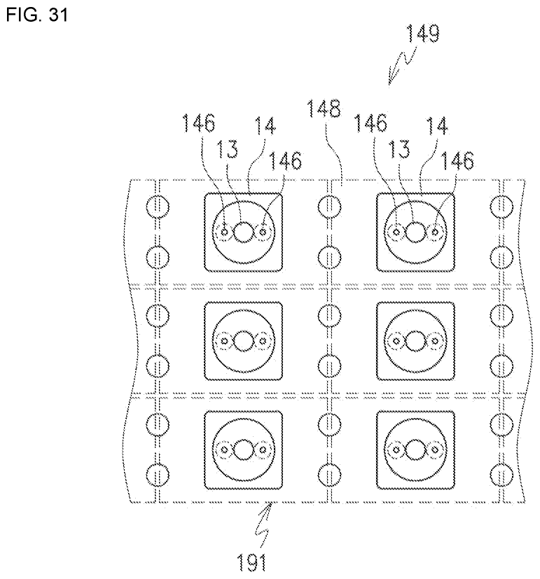

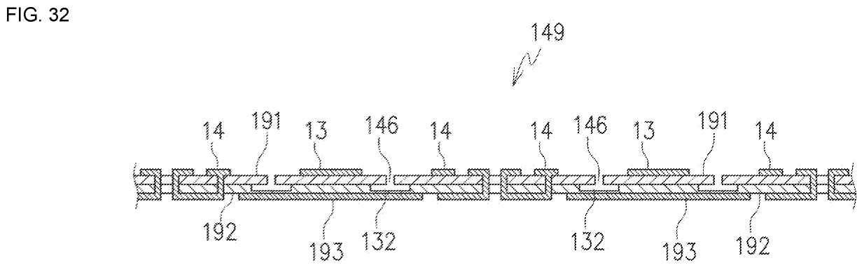

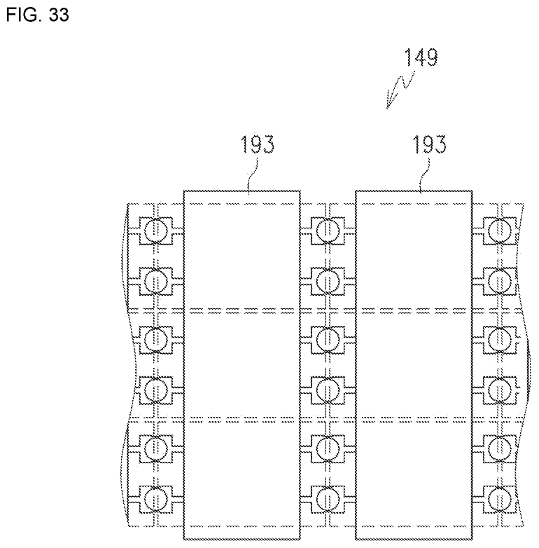

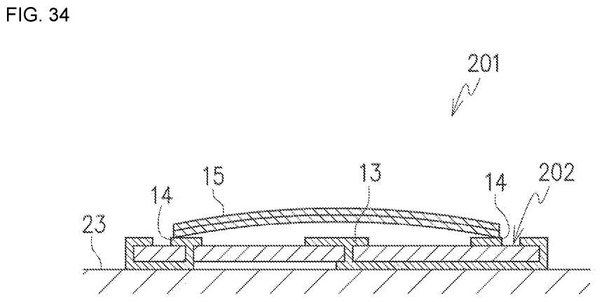

By referring to FIGS. 31 to 33, description will be made with regard to a method for producing the switch unit 111 using an aggregation method. FIG. 31 illustrates the upper surface of an aggregate switch substrate 149, which is a material of the switch substrate 43, which constitutes the switch unit 111 according to the tenth embodiment. FIG. 32 is a sectional view of the aggregate switch substrate 149. FIG. 33 illustrates the lower surface of the aggregate switch substrate 149. The method for producing a switch substrate 148 using the aggregation method includes a joining step and a cutting step.

In the joining step, the aggregate switch substrate 149 is obtained by joining a first aggregate substrate 191 and a second aggregate substrate 192 to each other. On the upper surface of the first aggregate substrate 191, a plurality of first contact points 13 and a plurality of second contact points 14 are formed. The plurality of second contact points 14 are provided around the respective first contact points 13. The first aggregate substrate 191 has a plurality of through holes 146. The second aggregate substrate 192 has a plurality of cavities 132. The maximum value of a sectional area of each cavity 132 parallel to the upper surface of the first aggregate substrate 191 is larger than the maximum value of a sectional area of each through hole 146 parallel to the upper surface of the first aggregate substrate 191. Each of the cavities 132 is open only on the upper surface of the second aggregate substrate 192. The plurality of through holes 146 overlap the plurality of respective cavities 132 in a vertical direction. In the cutting step, the aggregate switch substrate 149 is cut to obtain individual switch substrates 148. Between the joining step and the cutting step, it is possible to perform a forming step of forming a plurality of resin layers in a stripe arrangement on the lower surface of the aggregate switch substrate 149.

### REFERENCE SIGNS LIST

10, 100 Switch device
11, 31, 41, 51, 61, 71, 81, 91, 101, 111 Switch unit
12, 32, 42, 45′, 52, 62, 72, 82, 92, 102, 112, 112′ Substrate
12a, 12c Hard layer
12a′ Right and left outer circumference of hard layer
12b, 12d, 12e, 12f, 12g, 12h, 12j, 12k, 12m, 48 Soft layer
12d′ Right and left outer circumference of soft layer
13 First contact point
14 Second contact point
15, 15′ Conduction spring member
15a, 15a′ Apex of conduction spring member
16 Pressing element
17 Cover sheet
18 Frame sheet
18a Opening
19 External electrode
19a First wiring pattern
19b Second wiring pattern
20 External electrode
20a, 20c, 27a First external electrode
20b, 20d, 27b Second external electrode
21 Pressing aid member
22 Through hole
22a First through-hole electrode
22b Second through-hole electrode
23 Mount substrate
26 Pressing protrusion
26a Depression
28a First connection electrode
28b Second connection electrode
43, 148 Switch substrate
44 Aggregate switch substrate member
45 Aggregate substrate
46, 53, 146 Through hole
47 Conduction layer
48′ Soft plate
49, 149 Aggregate switch substrate
112a First substrate member
112b Second substrate member
112c Third substrate member
122 Through hole
131a, 131b, 131c, 131d, 141a, 141b, 151, 161, 171 Silencer
132, 132b, 142a, 142b, 152, 162, 172 Cavity
133a, 133b, 143, 153, 163, 173 Connection hole
134, 135, 144, 154, 164, 174 Opening
182a Aggregate first substrate
182b Aggregate second substrate
183 Lead portion
191 First aggregate substrate
192 Second aggregate substrate
193 Resin layer
201 Switch unit
202 Switch substrate

1. A switch unit comprising:
a substrate comprising a hard layer and a soft layer;
a first contact point provided on an upper surface of the substrate and above the soft layer;
a second contact point provided on the upper surface of the substrate and around the first contact point;
a conduction spring member provided in a non-contact state with the first contact point above the first contact point and in contact state with the second contact point, the conduction spring member being elastically deformable into contact with the first contact point to make a conduction between the first contact point and the second contact point;
a first external electrode and a second external electrode provided at end portions of the substrate;
a first wiring pattern provided on a lower surface of the substrate and electrically connected to the first external electrode; and
a second wiring pattern provided on the lower surface of the substrate and electrically connected to the second external electrode,
the hard layer being configured to receive a pressing force generated by pressing the conduction spring member and support the first contact point.

2. A switch unit comprising:
a substrate comprising a hard layer and a soft layer;
a first contact point provided on an upper surface of the substrate and above the soft layer;
a second contact point provided on the upper surface of the substrate and around the first contact point;
a conduction spring member provided in a non-contact state with the first contact point above the first contact point and in contact state with the second contact point, the conduction spring member being elastically deformable into contact with the first contact point to make a conduction between the first contact point and the second contact point;
a first external electrode and a second external electrode provided at end portions of the substrate;
a first connection electrode provided at an inside portion of the substrate and electrically connecting the first contact point and the first external electrode to each other; and
a second connection electrode provided at the inside portion of the substrate and electrically connecting the second contact point and the second external electrode to each other
the hard layer being configured to receive a pressing force generated by pressing the conduction spring member and support the first contact point.

3. The switch unit according to claim 1,
wherein the hard layer of the substrate is provided at an upper portion of the substrate, and the soft layer of the substrate is provided at a lower portion of the substrate, the soft layer comprising the first wiring pattern and the second wiring pattern on a lower surface of the soft layer,
wherein the first wiring pattern is electrically connected to a first through-hole electrode provided at an inside portion of the substrate and connected to the first contact point, and the second wiring pattern is electrically connected to the second through-hole electrode provided at the inside portion of the substrate and connected to the second contact point.

4. The switch unit according to claim 1, wherein the hard layer of the substrate comprises a pair of upper and lower hard layers, and the soft layer is held between the pair of upper and lower hard layers.

5. The switch unit according to claim 1, wherein the soft layer of the substrate is in contact with a lower surface of the first contact point, and the hard layer of the substrate is in contact with a lower surface of the second contact point and provided around the soft layer.

6. The switch unit according to claim 5, wherein the soft layer is thinner than the hard layer.

7. The switch unit according to claim 1, wherein an outer circumference of the soft layer is located at a position inner than the first external electrode and the second external electrode provided at the end portions of the substrate.

8. The switch unit according to claim 1, wherein an outer circumference of the first contact point is located at a position inner than an outer circumference of the soft layer, and the first through-hole penetrates the hard layer.

9. The switch unit according to claim 8, wherein the soft layer has a through hole immediately under the first contact point.

10. The switch unit according to claim 1, wherein an outer circumference of the soft layer has a size identical to a size of an outer circumference of the first contact point or has a smaller size than the size of the outer circumference of the first contact point.

11. The switch unit according to claim 1, wherein the soft layer has a Rockwell hardness of from 30 to 130 HRM.

12. The switch unit according to claim 1, wherein the hard layer is made of a glass epoxy resin, and the soft layer is made of a polyimide resin.

13. (canceled)

14. The switch unit according to claim 1, wherein the first wiring pattern has an area smaller than an area of the soft layer.

15. A method for producing a switch substrate, the method comprising:
a forming step of obtaining an aggregate switch substrate by forming a soft layer on a lower surface of an aggregate switch substrate member,
wherein the aggregate switch substrate member comprises
an aggregate substrate comprising a hard layer,
a plurality of first contact points provided on an upper surface of the aggregate substrate,
a plurality of second contact points provided on the upper surface of the aggregate substrate and around the respective first contact points,
a plurality of first through-hole electrodes provided at an inside portion of the aggregate substrate and electrically connected to the respective first contact points,
a plurality of second through-hole electrodes electrically connected to the respective second contact points,
a plurality of through holes extending between the upper surface and a lower surface of the aggregate substrate, each through hole of the through holes comprising a conduction layer as a side surface of the each through hole,
a plurality of first wiring patterns provided on a lower surface of the aggregate substrate, each first wiring pattern of the first wiring patterns being electrically connected to the conduction layer and each first through-hole electrode of the first through-hole electrodes, and
a plurality of second wiring patterns each electrically connected to the conduction layer and each second through-hole electrode of the second through-hole electrodes, and
wherein the soft layer covers at least portions immediately under the plurality of first contact points, and does not cover the plurality of through holes; and
a cutting step of obtaining individual switch substrates by cutting the aggregate switch substrate through at least the plurality of through holes.

16. (canceled)

17. A switch unit comprising:
a substrate comprising:
a first substrate member; a second substrate member provided under the first substrate member;
a cavity formed in the substrate, the cavity having a depth leaving a bottom of the second substrate member;
an opening formed on an upper surface of the substrate; and
a connection hole connecting the opening and the cavity to each other;
a first contact point provided on the upper surface of the substrate;
a second contact point provided around the first contact point; and
a conduction spring member provided in a non-contact state with the first contact point above the first contact point and in contact state with the second contact point, the conduction spring member being elastically deformable into contact with the first contact point to make a conduction between the first contact point and the second contact point,
wherein a maximum value of a sectional area of the connection hole parallel to the upper surface of the substrate is smaller than a maximum value of a sectional area of the cavity parallel to the upper surface of the substrate.

18-19. (canceled)

20. The switch unit according to claim 17, wherein the connection hole or the cavity comprises one or more than one connection hole or cavity formed around the first contact point, and has a ring shape or a liner shape.

21-22. (canceled)

23. The switch unit according to claim 17, wherein the cavity is formed immediately under the first contact point.

24. The switch unit according to claim 17, wherein the connection hole is formed in a direction perpendicular or inclined relative to the upper surface of the substrate.

25. The switch unit according to claim 17, wherein the connection hole and the cavity are identical in quantity such that one cavity is connected to one connection hole, and the connection hole is larger in quantity than the cavity such that a plurality of the connection holes are connected to one cavity.

26. (canceled)

27. The switch unit according to claim 17,
wherein the first contact point has a ring shape, and
wherein the opening is formed at a center of the first contact point on the upper surface of the substrate such that the opening is connected to the cavity.

28-32. (canceled)
